(19) United States
(12) Patent Application Publication
(10) Pub. No.: US 2008/0303339 A1
(43) Pub. Date: Dec. 11, 2008

(54) Wheel Hub With Axial Recesses Between the Holes For Wheel Bolts

(75) Inventors: Peter Niebling, Bad Kissingen (DE); Robert Plank, Weisendorf (DE); Heinrich Hofmann, Schweinfurt (DE); Horst Doeppling, Herzogenaurach (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/158,443

(22) PCT Filed: Dec. 9, 2006
(86) PCT No.: PCT/DE2006/002194

§ 371 Date: Aug. 4, 2008

(30) Foreign Application Priority Data
Dec. 22, 2005 (DE) 10 2005 061 389.6

(51) Int. Cl. B60B 27/00

(52) U.S. Cl. 301/106

(57) ABSTRACT

The invention relates to a wheel hub having a central section and having a radial section which radially adjoins said central section, having a bearing section which projects axially from the central section for holding a wheel bearing and having an axially opposite holding section for holding a brake disk and a wheel rim, wherein holes for holding wheel bolts are formed in the radial section. In order to obtain a particularly light wheel hub which can withstand all operating loads and offers a reliable contact face for a brake disk under all operating conditions, it is provided that the wheel hub has recesses at least between some holes, which recesses extend completely through the wall of the radial section of the wheel hub, and that stiffening ribs are formed between the respective recesses which stiffening ribs axially thicken the radial section between the recesses.

### FIELD OF THE INVENTION

The invention relates to a wheel hub having a central section and a radially adjoining radial section, having a bearing section which protrudes axially from the central section and has the purpose of holding a wheel bearing, and having a holding section which lies axially opposite and has the purpose of holding a brake disk and a wheel rim, wherein holes for holding wheel bolts are formed in the radial section.

### BACKGROUND OF THE INVENTION

Wheel hubs for motor vehicles are known to a person skilled in the art in a large number of embodiment varieties. They are used in the motor vehicle as a joining element between a drive shaft and a vehicle wheel. For connection to the drive shaft, a wheel hub usually has a central holding section with a plug-type toothing into which the free end of the drive shaft can be plugged. In order to attach the rim of a vehicle wheel, holes with a screwed thread are formed on a radial section of the wheel hub and wheel bolts can be screwed into said holes with the intermediate positioning of a brake disk. In addition, wheel hubs usually have an axial section for holding and radially centering the wheel rim or the brake disk.

It is also known that such wheel hubs are provided with non-continuous material cutouts in order to reduce the masses rotating with the vehicle wheel when the vehicle is operating, as a result of which the driving properties of the vehicle can be improved.

### OBJECT OF THE INVENTION

Against this background, the object of the invention is to develop such a wheel hub in such a way that the mass of conventional wheel hubs with comparable dimensions can be reduced further. In this context, the wheel hub should have a high degree of resistance against tilts and warping, and ensure precise guidance of the brake disk and of the rim both with respect to the tightening torques of the wheel bolts and with respect to forces acting during operation.

### SUMMARY OF THE INVENTION

In order to achieve this object, a wheel hub having the features of the main claim is provided. Advantageous developments and refinements of the invention can be found in the subclaims.

Accordingly, a wheel hub is proposed having a central section and a radially adjoining radial section, having a bearing section which protrudes axially from the central section and has the purpose of holding a wheel bearing and having a holding section which lies axially opposite and has the purpose of holding a brake disk and a wheel rim, wherein holes for holding wheel bolts are formed in the radial section. In order to achieve the object set, there is also provision that the wheel hub has, at least between some of the holes, cutouts which completely penetrate the wall of the radial section of the wheel hub, and that reinforcing ribs, which axially thicken the radial section between the cutouts, are formed between the respective cutouts.

The proposed design provides a wheel hub which has axial device components for connecting to a vehicle drive shaft, for holding a wheel bearing and for holding a brake disk and a wheel rim. Furthermore, this wheel hub has a radial section which, to a high degree, constitutes a lightweight structure as a result of the holes for the wheel bolts and the continuous cutouts. The spoke-shaped reinforcing ribs ensure that the wheel hub can withstand all operating loads. According to the respective dimensions and/or mechanical requirements made of the wheel hub, said hub can be constructed in line with the following features.

In one preferred embodiment variant there is provision for the cutouts to be formed between, in each case, two holes in the radial section. Even though this means that a comparatively lightweight wheel hub is provided, it does not necessarily have to be embodied in this way. It is, instead, also possible that the aforesaid cutouts in each case enclose between them, for example, a plurality of the holes for holding the wheel bolts.

Another development of the invention provides that the reinforcing ribs are formed only on one axial side of the wheel hub. This reduces the production expenditure in terms of casting technology and therefore lowers the production costs of such a wheel hub. There is preferably provision here for the reinforcing ribs to be formed on that side of the wheel hub on which the bearing section for a wheel bearing protrudes axially from the wheel hub. This design entails the advantage that the reinforcing ribless side of the wheel hub lying opposite can form a planar bearing face for the brake disk and the wheel rim.

There is also preferably provision for each of the reinforcing ribs to be formed on the wheel hub in such a way that it engages around one of the holes for the bolt screws. As a result, that region of the wheel hub in which a drive torque is transmitted by the wheel hub to the vehicle wheels via the wheel bolts is advantageously embodied in a mechanically strengthened fashion.

The cutouts and the reinforcing ribs preferably have an essentially trapezoidal, kidney-shaped or triangular cross section in the radial plane of the radial section of the wheel hub, as a result of which, on the one hand, it is possible to eliminate a comparatively large amount of weight-increasing material of the wheel hub and, on the other hand, the reinforcing ribs have an appropriate geometry. In this context, the cutouts are formed on the wheel hub in such a way that their short side points radially inward in the direction of the rotational axis of the wheel hub, while the short side of the reinforcing ribs point radially outward.

A further feature of a wheel hub according to the invention may be that the central section of the same is of conical design, wherein this central section tapers axially in the direction of the bearing section for the wheel bearing. In this context it is to be noted that it may be advantageous if the cutouts extend radially into the conical region of the central section, and if the reinforcing ribs adjoin, with their radially inner end, the radially outer end of the central section.

In order to be able to ensure a force profile in the wheel hub which is as low in stress as possible, the invention also provides for the reinforcing ribs to have end faces which point in the rotational direction of the wheel hub, and a radial face which connects these two end faces radially on the outside, wherein the respective radial faces of the reinforcing ribs adjoin, in an axially flush manner, the essentially cylindrical circumferential face of the wheel hub, or can even be set back. This arrangement serves simultaneously also as a protection against injury when transporting and mounting such a wheel hub.

In this context it is also appropriate if the reinforcing ribs have a circumferential face which runs around radially and which is at an oblique angle with respect to the longitudinal axis of the wheel hub, and engages around all the reinforcing ribs and the radially outer end of the central section.

Finally, it is possible to provide that the reinforcing ribs each have a planar radial face which reduces the expenditure on producing a casting mold for this purpose and on the wheel hub itself.

### BRIEF DESCRIPTION OF THE DRAWINGS

The invention will be explained in more detail below using an exemplary embodiment and with reference to the appended drawing, in which:

FIG. 1 shows a wheel hub which is embodied according to the invention, viewed from the drive side and wheel bearing side, and

FIG. 2 shows a wheel hub according to FIG. 1, illustrated from the opposite side.

### DETAILED DESCRIPTION OF THE DRAWINGS

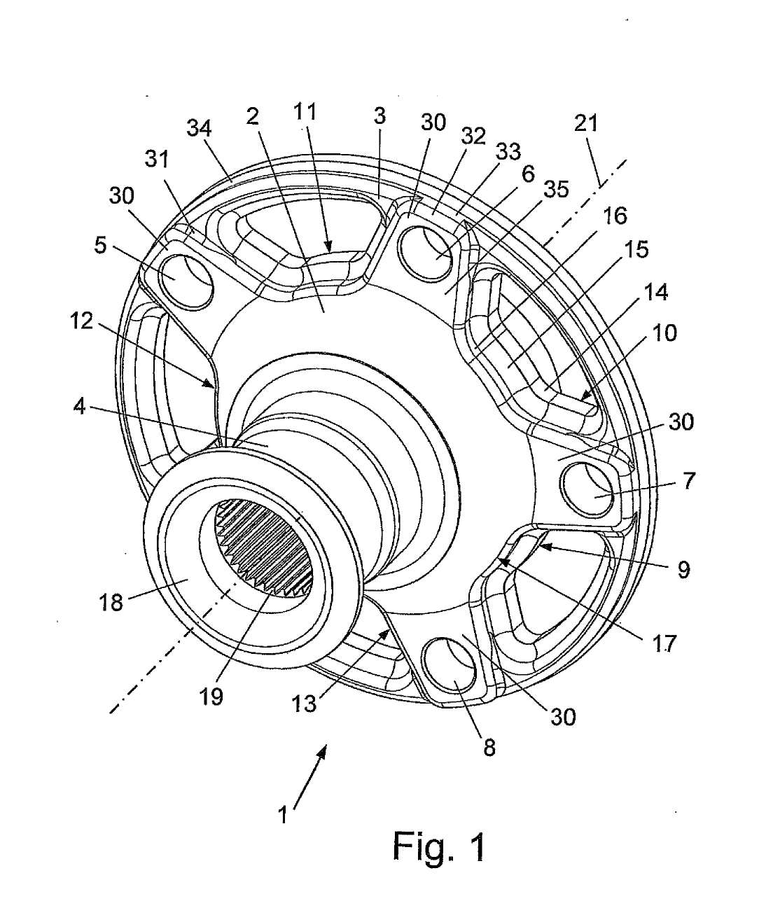

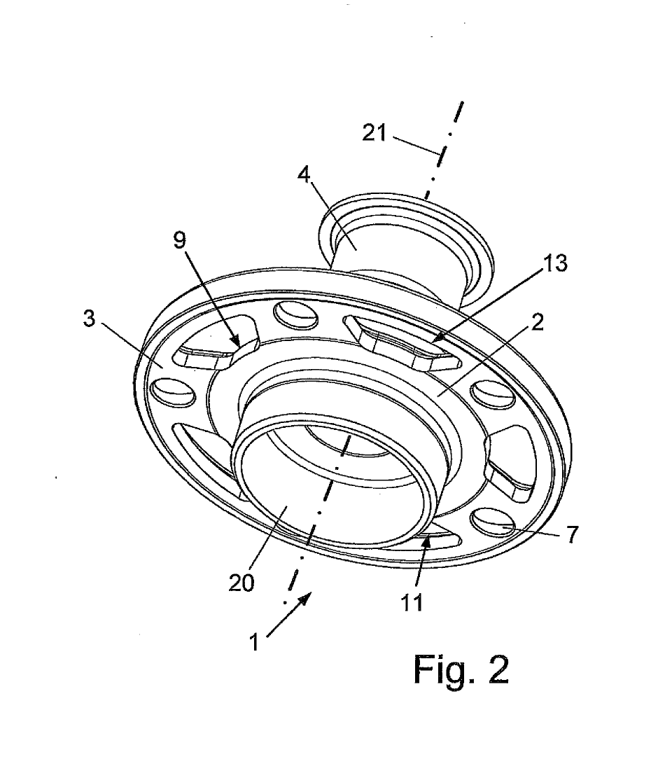

As is clarified by FIGS. 1 and 2, a wheel hub 1 which is embodied according to the invention comprises firstly a central section 2 which is embodied essentially perpendicularly to the rotational axis 21 of the wheel hub 1. A bearing section 4 for holding a wheel bearing (not shown), and opposite this a stepped holding section 20 for holding and centering a brake disk (not illustrated here) and a wheel rim (also not illustrated here) extend from this central section 2, in a coaxial direction with respect to the rotational axis 21. The bearing section 4 is constructed in such a way that an inner ring of the wheel bearing can be attached to its radial outer face, while a plug-type toothing 19 for holding an axially toothed journal of a drive shaft is formed in the axial bore of said wheel bearing. The free axial end of the bearing section 4 is bounded by an annular bead 18.

The central section 2 of the wheel hub 1 is embodied in this exemplary embodiment so as to be conical with respect to the rotational axis 21, wherein the diameter of this central section 2 decreases from the radially outer side in the direction of the bearing section 4. The central section 2 merges at its circumference with the largest diameter with a radial section 3 which serves to attach the brake disk and wheel rim which are fitted onto the holding section 20 of the wheel hub 1. In this context, at least the wheel rim can be attached to the radial section 3 of the wheel hub 1 by means of wheel bolts. For this purpose, the wheel bolts are screwed into the holes 5, 6, 7, and 8 which are provided with a screw thread (not illustrated).

Cutouts 9, 10, 11, 12, and 13 which engage through the radial wall of the wheel hub 1 are formed in said wheel hub 1 and are arranged and distributed evenly between the holes 5, 6, 7 and 8. In the exemplary embodiment illustrated in FIGS. 1 and 2, the cutouts 9, 10, 11, 12 and 13 have an essentially trapezoidal cross-sectional geometry in the radial plane. In this context, the longer side of the cutouts with respect to the circumference are formed radially on the outside, and the shorter side with respect to the circumference are formed radially on the inside of the radial section 3. As these FIGS. 1 and 2 show clearly, the cutouts 9, 10, 11, 12 and 13 can extend radially into the conical central section 2.

The cutouts 9, 10, 11, 12 and 13 each have, viewed in the direction of the bearing section 4, three axial sections 14, 15 and 16, the first axial section 14 of which has wall faces which are oriented essentially parallel to the rotational axis 21 or perpendicular to the radial plane of the radial section 3, while the wall faces of the two adjoining axial sections 15 and 16 are positioned with different angles, and with angles which decrease axially with respect to one another, of less than 90° with respect to the radial plane. As a result of this, a large degree of rounding of the edges of the cutouts 9, 10, 11, 12 and 13 which protects the material structure of the wheel hub 1 is provided.

In addition, according to another advantageous embodiment, it is possible to provide that the recesses 9, 10, 11, 12 and 13 have an arcuate profile 17 on their radially inner side and/or all have rounded corners. As a result, the cutouts 9, 10, 11, 12 and 13 have an approximately kidney-shaped geometry. As a result of the described design of the edges and of the sides of the cutouts 9, 10, 11, 12 and 13, a low-stress force profile within the wheel hub 1 is also implemented.

According to one important aspect of the invention, there is provision that the wheel hub 1 has reinforcing ribs 30 on at least one of its radial faces lying opposite, which radial faces extend from the central section 2 to the radial end of the wheel hub 1. These reinforcing ribs 30 are each formed between the cutouts 9, 10, 11, 12 and 13 and as a result extend the axial length of the holes 5, 6, 7, and 8 for holding the above-mentioned wheel bolts. In other words, as a result the wheel hub 1 has a spoke-like reinforcing sections 30 which start radially on the inside on the central section 2 and extend radially outwards as far as the outer end of the radial section 3. As a result of this design, a very lightweight and nevertheless flexurally rigid wheel hub is provided, which absorbs without being damaged all the operational loads acting thereon.

Each of the reinforcing ribs 30 is preferably embodied in such a way that it has end faces 31 pointing in the rotational direction of the wheel hub 1 and a radial face 33 which connects these two end faces 31 radially on the outside. The respective radial faces 33 of the reinforcing ribs 30 adjoin, in an axially flush manner, the essentially cylindrical circumferential face 34 of the wheel hub 1. Furthermore, this wheel hub 1 has a circumferential face 32 which runs around and which is at an oblique angle with respect to the longitudinal axis 21 of the wheel hub 1, and engages around all the reinforcing ribs 30 and the radially outer end of the central section 2. Finally, the reinforcing ribs 30 have planar axial faces 35.

The described design of the faces 31, 32, 33, 34 and 35 of the wheel hub 1 permit a torque which is supplied by a drive shaft to the wheel hub 1 to be passed on with low stress to a wheel rim attached there or to a brake disk, and permits the wheel hub to be handled without injury when transporting and mounting it.

The rear side of the wheel hub 1 with the holding section 20 for a brake disk and wheel rim 1 is of preferably planar design in the radial section 3 in order to form a bearing face for a brake disk and/or a wheel rim which is not corrugated with respect to the circumference.

### LIST OF REFERENCE NUMERALS

1 Wheel hub
2 Central section
3 Radial section
4 Bearing section
5 Hole for wheel bolt
6 Hole for wheel bolt
7 Hole for wheel bolt
8 Hole for wheel bolt
9 Cutout
10 Cutout
11 Cutout
12 Cutout
13 Cutout
14 First axial section
15 Second axial section
16 Third axial section
17 Arcuate profile of cutout
18 Annular bead
19 Plug-type toothing
20 Holding section for brake disk and wheel rim
21 Rotational axis
30 Reinforcing rib
31 End face of a reinforcing rib
32 Circumferential face of the reinforcing ribs
33 Radial face of a reinforcing rib
34 Circumferential face of the wheel hub
35 Radial face of a reinforcing rib

1. A wheel hub comprising a central section and a radially adjoining radial section, having a bearing section which protrudes axially from the central section and has the purpose of holding a wheel bearing and having a holding section which lies axially opposite and has the purpose of holding a brake disk and a wheel rim, wherein holes for holding wheel bolts are formed in the radial section, wherein the wheel hub has, at least between some of the holes, cutouts which completely penetrate the wall of the radial section of the wheel hub, and in that reinforcing ribs, which axially thicken the radial section between the cutouts, are formed between the respective cutouts.

2. The wheel hub as claimed in claim 1, characterized in wherein the cutouts are formed between, in each case, two holes in the radial section.

3. The wheel hub as claimed in claim 1, wherein the reinforcing ribs are formed only on one side of the wheel hub.

4. The wheel hub as claimed in claim 3, wherein the reinforcing ribs are formed on that side of the wheel hub on which the bearing section protrudes axially from the wheel hub.

5. The wheel hub as claimed in claim 1, wherein each of the reinforcing ribs is formed so as to engage around one of the holes.

6. The wheel hub as claimed in claim 1, wherein the cutouts and the reinforcing ribs have an essentially trapezoidal, kidney-shaped or triangular cross section in the radial plane of the radial section.

7. The wheel hub as claimed in claim 5, wherein the cutouts are formed on the wheel hub in such a way that their short side points radially inward in the direction of the rotational axis of the wheel hub, while the short side of the reinforcing ribs points radially outward.

8. The wheel hub as claimed in claim 1, wherein the central section is of conical design, wherein the central section tapers axially in the direction of the bearing section.

9. The wheel hub as claimed in claim 1, wherein the reinforcing ribs adjoin, with their radially inner end, the radially outer end of the central section.

10. The wheel hub as claimed in claim 1, wherein the reinforcing ribs have end faces which point in the rotational direction of the wheel hub, and a radial face which connects these two end faces radially on the outside, wherein the respective radial faces of the reinforcing ribs adjoin, in an axially flush manner, the essentially cylindrical circumferential face of the wheel hub, or are set back.

11. The wheel hub as claimed in claim 1, wherein the reinforcing ribs have a circumferential face which runs around radially and which is at an oblique angle with respect to the longitudinal axis of the wheel hub, and engages around all the reinforcing ribs and the radially outer end of the central section.

12. The wheel hub as claimed in claim 1, wherein the reinforcing ribs each have a planar radial face.
